(19) United States
(12) Patent Application Publication
(10) Pub. No.: US 2014/0375555 A1
(43) Pub. Date: Dec. 25, 2014

(54) WORK SUPPORT SYSTEM, WORK SUPPORT APPARATUS, WORK SUPPORT METHOD, AND COMPUTER READABLE STORAGE MEDIUM

(71) Applicant: NEC Solution Innovators, Ltd., Tokyo (JP)

(72) Inventors: Kenichi Kaneko, Tokyo (JP); Katsuyuki Nagai, Tokyo (JP); Teppei Takasugi, Tokyo (JP)

(21) Appl. No.: 14/376,238

(22) PCT Filed: Dec. 25, 2012
(86) PCT No.: PCT/JP2012/008284

§ 371 Date: Aug. 1, 2014

(30) Foreign Application Priority Data
Feb. 3, 2012 (JP) 2012-0223112

(51) Int. Cl. G06F 3/01

(52) U.S. Cl. CPC G06F 3/017
USPC 345/156

(57) ABSTRACT

An imaging unit (210) images a front side of a disposition unit (300). A distance measuring unit (220) calculates a distance (for example, a distance in a Y direction in FIG. 1) from the distance measuring unit (220) to a hand positioned in front of the disposition unit (300). A work support apparatus (100) analyzes image data obtained by the imaging of the imaging unit (210), and calculates the position of the hand in a direction (for example, in an X direction in FIG. 1) that is across a straight line that connects the disposition unit (300) and the imaging unit (210). Further, the work support apparatus (100) specifies a disposition area (310) to which the hand extends based on the analysis result of the image data and the measurement result of the distance measuring unit (220).

### TECHNICAL FIELD

The present invention relates to a work support system, a work support apparatus, a work support method, and a program.

### BACKGROUND ART

As a technique that detects hand extension toward an article displayed on a shelf, techniques disclosed in Patent Documents 1 and 2 have been proposed. Patent Document 1 discloses a technique in which coordinates of the hand are calculated using a laser and a shelf accessed by the hand is specified based on the calculation result. The technique disclosed in Patent Document 2 is a technique in which a distance sensor is provided on each of plural shelves and an article accessed by the hand is specified based on the measurement result of the distance sensor.

### RELATED DOCUMENT

### Patent Document

[Patent Document 1] Japanese Unexamined Patent Publication No. 2007-323471
[Patent Document 2] Japanese Unexamined Patent Publication No. 2009-126660

### DISCLOSURE OF THE INVENTION

The present inventors found that in the related art techniques of Patent Documents 1 and 2 there was a possibility that when an object other than the hand accessed the shelf, the object was falsely detected as the hand.

An object of the invention is to provide a work support system, a work support apparatus, a work support method, and a program capable of detecting hand extension toward an article with a low possibility of false detection.

According to an aspect of the invention, there is provided a work support system including: an image generating unit that generates image data indicating an area in front of a disposition unit in which a plurality of disposition areas where an article is to be disposed are arranged; a distance measuring unit provided in a first direction with reference to the disposition unit that measures a distance to a hand that extends toward the disposition unit; an image analyzing unit that analyzes the image data and calculates an angle of a straight line that connects the image generating unit and the hand; and a disposition area specifying unit that specifies the disposition area to which the hand extends based on the analysis result of the image analyzing unit and the measurement result of the distance measuring unit.

According to another aspect of the invention, there is provided a work support apparatus that is connected to a measuring unit including: an image generating unit that generates image data indicating an area in front of a disposition unit in which a plurality of disposition areas where an article is to be disposed are arranged; a distance measuring unit provided in a first direction with reference to the disposition unit that measures a distance to a hand that extends toward the disposition unit; and an image analyzing unit that analyzes the image data and calculates an angle of a straight line that connects the image generating unit and the hand, in which the work support apparatus includes a disposition area specifying unit that specifies the disposition area to which the hand extends based on the analysis result of the image processing unit and the measurement result of the distance measuring unit.

According to still another aspect of the invention, there is provided a work support method using a work support apparatus that is connected to a measuring unit including: an image generating unit that generates image data indicating an area in front of a disposition unit in which a plurality of disposition areas where an article is to be disposed are arranged; a distance measuring unit provided in a first direction with reference to the disposition unit that measures a distance to a hand that extends toward the disposition unit; and an image analyzing unit that analyzes the image data and calculates an angle of a straight line that connects the image generating unit and the hand, in which the work support apparatus obtains the analysis result of the image analyzing unit, obtains distance information that is the measurement result of the distance measuring unit, and specifies the disposition area to which the hand extends based on the analysis result and the distance information.

According to still another aspect of the invention, there is provided a program that causes a computer that is connected to measuring unit to function as a work support apparatus, the measuring unit including: an image generating unit that generates image data indicating an area in front of a disposition unit in which a plurality of disposition areas where an article is to be disposed are arranged; distance measuring unit provided in a first direction with reference to the disposition unit that measures a distance to a hand that extends toward the disposition unit; and an image analyzing unit that analyzes the image data and calculates an angle of a straight line that connects the image generating unit and the hand, in which the program causes the computer to realize a function of obtaining the analysis result of the image analyzing unit, a function of obtaining distance information that is the measurement result of the distance measuring unit, and a function of specifying the disposition area to which the hand extends based on the analysis result and the distance information.

According to the invention, it is possible to detect that the hand extends toward an article, and to reduce a possibility of false detection.

### BRIEF DESCRIPTION OF THE DRAWINGS

The above object and other objects, features and advantages will be apparent from preferred embodiments described below and the accompanying drawings.

FIG. 1 is a diagram illustrating a use environment of a work support system according to a first embodiment.

FIG. 2 is a diagram illustrating a use environment of a work support system according to a first embodiment.

FIG. 3 is a block diagram showing a functional configuration of a work support apparatus.

FIG. 4 is a diagram illustrating a functional configuration of a work support apparatus according to a second embodiment.

FIG. 5 is a diagram illustrating information stored in an area information storage unit in a table form.

FIG. 6 is a diagram illustrating information stored in a history storage unit in a table form.

FIG. 7 is a block diagram illustrating a function configuration of a work support apparatus according to a third embodiment.

FIG. 8 is a diagram illustrating a data configuration of an area information storage unit in a table form.

FIG. 9 is a flowchart illustrating a process performed by a work support apparatus.

FIG. 10 is a block diagram illustrating a configuration of a work support system according to a fourth embodiment.

FIG. 11 is a block diagram illustrating a functional configuration of a work support apparatus shown in FIG. 10.

FIG. 12 is a plan view illustrating a work support apparatus according to a fifth embodiment.

FIG. 13 is a block diagram illustrating a functional configuration of the work support apparatus shown in FIG. 12.

FIG. 14 is a diagram illustrating a configuration of a work support system according to a sixth embodiment.

FIG. 15 is a diagram illustrating a configuration of a work support system according to a seventh exemplary embodiment.

### DESCRIPTION OF EMBODIMENTS

Hereinafter, embodiments of the invention will be described with reference to the accompanying drawings. In all the drawings, the same reference signs are given to the same components, and thus, the redundant description will not be repeated.

### First Embodiment

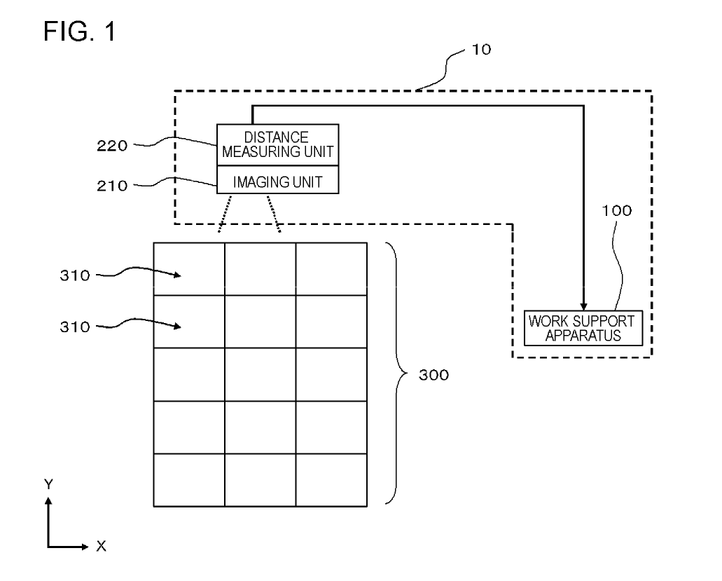

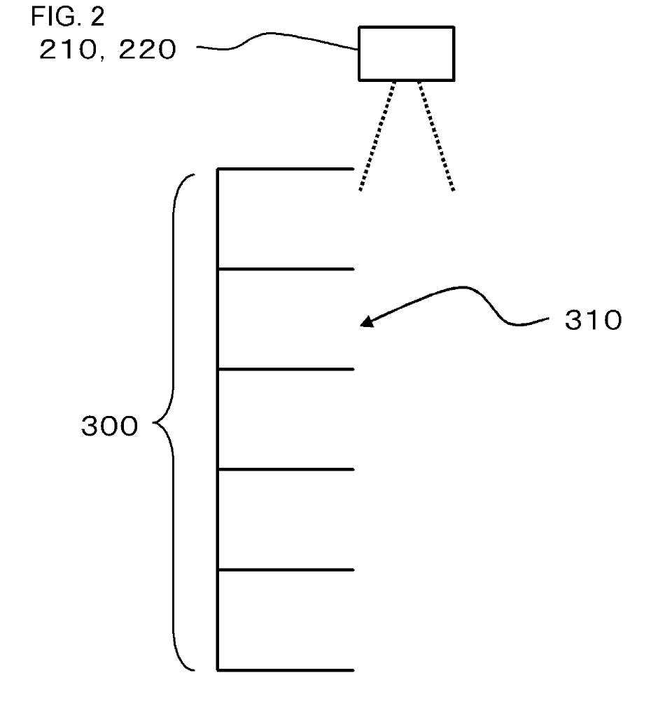

FIGS. 1 and 2 are diagrams illustrating a use environment of a work support system 10 according to a first embodiment. The work support system 10 is used together with a disposition unit 300. FIG. 1 shows a front view of the disposition unit 300, and FIG. 2 shows a side view of the disposition unit 300. The disposition unit 300 includes plural disposition areas 310. The disposition unit 300 is a shelf of plural stages, for example, which has a shape in which the disposition areas 310 of a box shape are stacked in a longitudinal direction and in a transverse direction. Here, in a boundary of the disposition areas 310 that are adjacent to each other in the transverse direction, a partition may not be provided. An article is accommodated in the disposition area 310. As shown in FIG. 2, a front portion of the disposition area 310 is opened. By extending a hand to the disposition area 310 through the opened portion, it is possible to extract the article in the disposition area 310.

The disposition unit 300 may have a configuration in which plural containers are disposed. In this case, the disposition area 310 corresponds to the container. The container may be a tray or a water tank. Further, the disposition unit 300 may be a display shelf of a single stage. In this case, a partition may not be provided between the adjacent disposition areas 310.

The work support system 10 includes an imaging unit 210, a distance measuring unit 220, and a work support apparatus 100. The imaging unit 210 and the distance measuring unit 220 are mounted to sense a front side (that is, the front of the opened portion) of the disposition unit 300. The work support apparatus 100 may be provided at a location (for example, an office) separated from the disposition unit 300, for example. In an example shown in FIG. 2, the imaging unit 210 and the distance measuring unit 220 are mounted above the disposition unit 300. In this case, it is possible to suppress a motion of a person from being obstructed by the imaging unit 210 and the distance measuring unit 220. Here, the imaging unit 210 and the distance measuring unit 220 may be mounted on a lateral side of the disposition unit 300.

The imaging unit 210 images the front side of the disposition unit 300. The distance measuring unit 220 is mounted in a first direction with reference to the disposition unit 300, and calculates a distance from the distance measuring unit 220 to the hand positioned in front of the disposition unit 300 (for example, a distance in a Y direction in FIG. 1: the position of the hand in the first direction). The distance measuring unit 220 is a distance sensor using an infrared ray, for example, but may be a distance sensor using a supersonic wave. Image data generated by the imaging unit 210 and the distance calculated by the distance measuring unit 220 are output to the work support apparatus 100.

The work support apparatus 100 analyzes the image data obtained by the imaging of the imaging unit 210, and calculates an angle of a straight line that connects the imaging unit 210 and the hand. Further, the work support apparatus 100 specifies the disposition area 310 to which the hand extends based on the analysis result of the image data and the measurement result of the distance measuring unit 220.

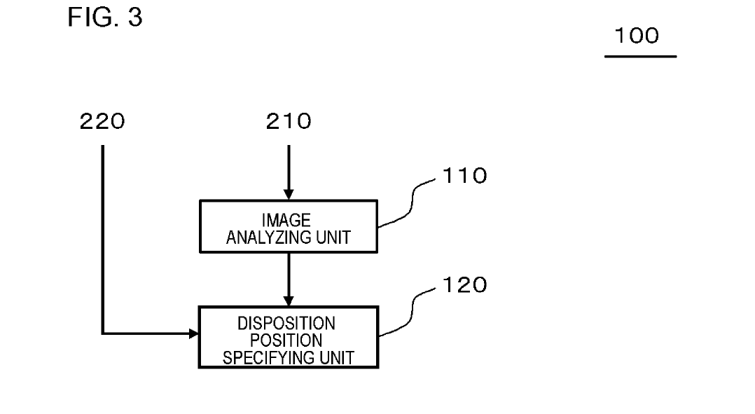

FIG. 3 is a block diagram illustrating a functional configuration of the work support apparatus 100. The work support apparatus 100 includes an image analyzing unit 110 and a disposition position specifying unit 120. The image analyzing unit 110 analyzes the image data obtained by the imaging of the imaging unit 210, and calculates the angle of the straight line that connects the imaging unit 210 and the hand. Here, for example, the center of the image data is set as the origin (zero point) of the angle, but a different point may be set as the origin. The image analyzing unit 110 calculates the position (an X coordinate and a Y coordinate in the drawing) of the hand based on the calculated angle and the distance measured by the distance measuring unit 220. Here, the image analyzing unit 110 is able to distinguish between the hand and a different object (for example, the head, a bag or the like) by using shape information (outline information) on an object specified from the image data with high accuracy.

The respective components of the work support apparatus 100 shown in FIG. 3 show blocks of a function unit, instead of a configuration of a hardware unit. The respective components of the work support apparatus 100 may be realized by an arbitrary combination of hardware and software such as a CPU, a memory, a program loaded on the memory to realize the components shown in FIG. 3, a storage medium such as a hard disk in which the program is stored, and an interface for network connection, in an arbitrary computer. Further, the realization method and apparatus include various modification examples. This is similarly applied to the other embodiments to be described later.

Next, an operation and effects of the present embodiment will be described. According to the present embodiment, first, the image analyzing unit 110 calculates the position of the hand in the X direction in FIG. 1 through image processing. Thus, it is possible to suppress an object other than the hand from being detected falsely as the hand.

Further, the position of the hand in the Y direction in FIG. 1 is measured by the distance measuring unit 220. The image analyzing unit 110 does not have to calculate the position of the hand in the Y direction. Accordingly, the image analyzing unit 110 has a small amount of arithmetic operations, and performs the calculation with high accuracy.

Further, the imaging unit 210 and the distance measuring unit 220 may be added later to the disposition unit 300. Further, since the distance measuring unit 220 is used, even if the disposition unit 300 is in a relatively dark environment, it is possible to determine which disposition area 310 the hand extends toward.

### Second Embodiment

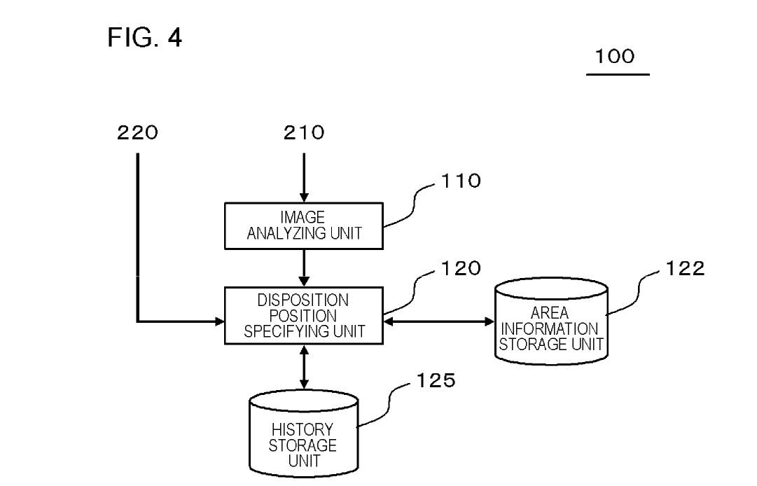

FIG. 4 is a diagram illustrating a functional configuration of a work support apparatus 100 according to a second embodiment. A work support system 10 according to the present embodiment has the same configuration as in the work support system 10 according to the first embodiment, except for the functional configuration of the work support apparatus 100. The work support apparatus 100 is used for marketing, for example. In this case, a disposition unit 300 is a product display shelf. Further, in plural disposition areas 310, different articles of commerce are respectively displayed. The work support apparatus 100 detects which article a customer extends the hand toward.

The work support apparatus 100 according to the present embodiment has the same configuration as in the work support apparatus 100 according to the first embodiment, except for inclusion of an area information storage unit 122 and a history storage unit 125.

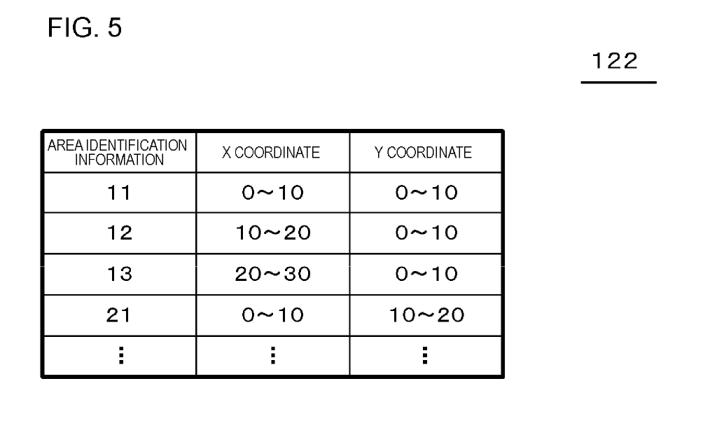

FIG. 5 is a diagram illustrating information stored in the area information storage unit 122 in a table form. The area information storage unit 122 stores a range (for example, the X coordinate) of the position of the hand in the calculation result of the image analyzing unit 110 and a range of the distance (for example, the Y coordinate) of the hand in the measurement result of the distance measuring unit 220, respectively, for each of the plural disposition areas (for each piece of area identification information). Further, the disposition position specifying unit 120 matches the combination of the calculation result of the image analyzing unit 110 and the measurement result of the distance measuring unit 220 with the information stored in the area information storage unit 122, to thus make it possible to recognize the area identification information indicating the disposition area to which the hand extends.

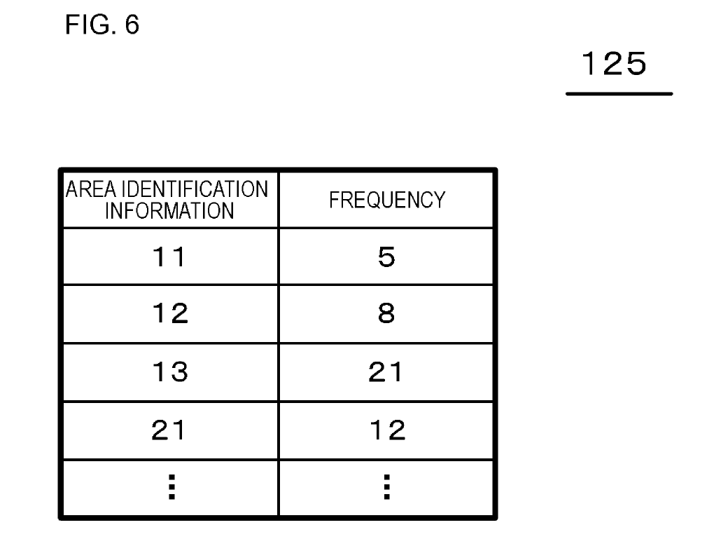

FIG. 6 is a diagram illustrating information stored in the history storage unit 125 in a table form. The history storage unit 125 stores the number of extensions of the hand to the disposition area 310, for each piece of area identification information, corresponding to the area identification information. If it is detected that the hand extends to a certain disposition area 310, the disposition position specifying unit 120 increases the number of extensions stored in the history storage unit 125 corresponding to the area identification information on the disposition area 310 by one. The information stored in the history storage unit 125 represents the number of extensions of the hand, for each article, to the article. Here, the image analyzing unit 110 may detect whether the hand extracts the article through image processing. Further, the history storage unit 125 may distinctly store the number of extractions of the article by the hand and the number of non-extractions of the article by the hand extension.

As described above, according to the present embodiment, it is possible to achieve the same effects as in the first embodiment. Further, the work support apparatus 100 counts the number of extensions of the hand, for each article, to the article. Accordingly, a user of the work support apparatus 100 can determine in which article customers are interested based on the information stored in the history storage unit 125. This information includes the number of persons who hold the article with the hand but do not purchase the article. Accordingly, by analyzing the information stored in the history storage unit 125, it is possible to obtain information different from that on a purchase history.

### Third Embodiment

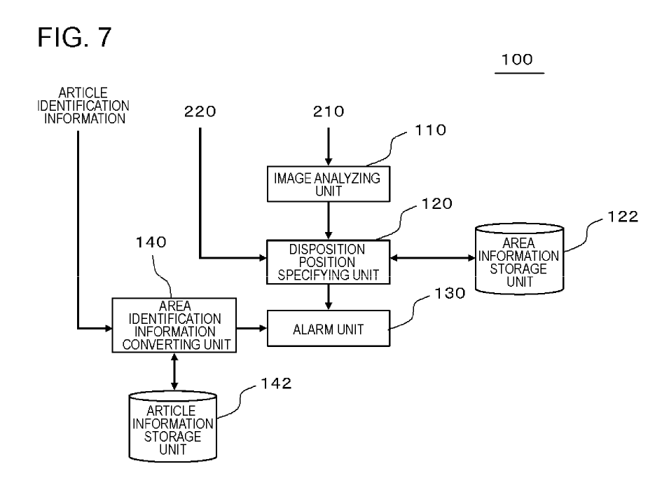

FIG. 7 is a block diagram illustrating a functional configuration of a work support apparatus 100 according to a third embodiment. A work support system 10 according to the present embodiment has the same configuration as in the work support system 10 according to the first embodiment, except for the functional configuration of the work support apparatus 100. In the present embodiment, the work support apparatus 100 has the same configuration as in the work support apparatus 100 according to the first embodiment, except for inclusion of an area information storage unit 122, an alarm unit 130, an area identification information converting unit 140, and an article information storage unit 142.

In the present embodiment, in each disposition area 310 of a disposition unit 300, a component or a raw material (including a chemical) is disposed. A worker extracts a designated component or raw material from the disposition unit 300. The work support apparatus 100 supports the worker to extract a correct component or raw material.

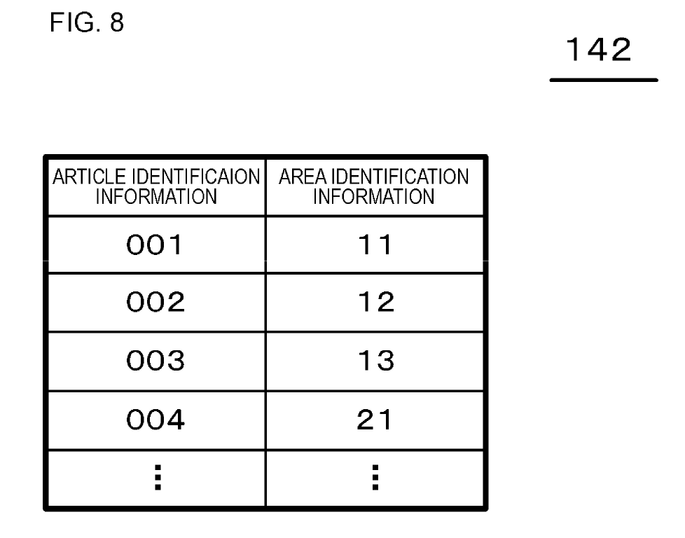

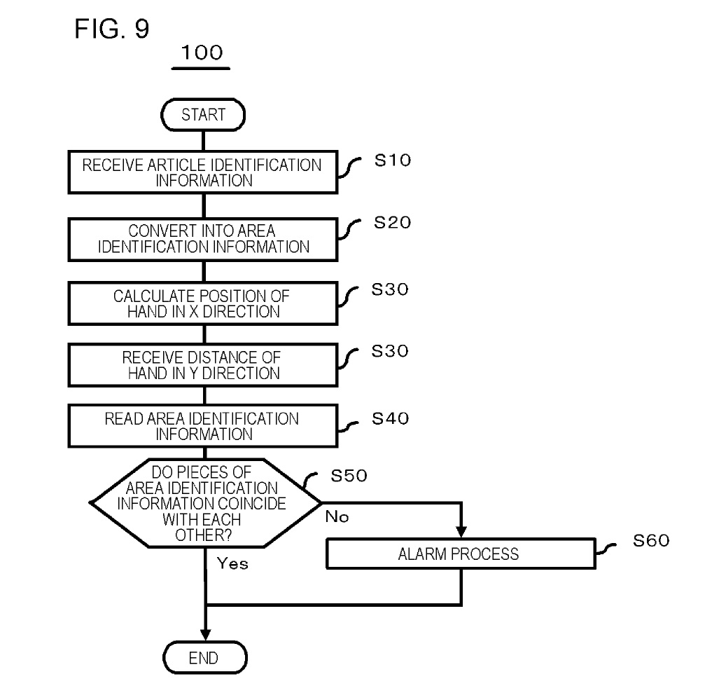

A data configuration of the area information storage unit 122 is the same as in the description using FIG. 5 in the second embodiment. A data configuration of the article information storage unit 142 will be described with reference to FIG. 8. Further, functions of the area identification information converting unit 140 and the alarm unit 130 will be described with reference to FIG. 9.

FIG. 8 is a diagram illustrating the data configuration of the article information storage unit 142 in a table form. The article information storage unit 142 stores article identification information for identifying an article or a raw material in association with the area identification information of the disposition area 310 where the article or the raw material is disposed.

FIG. 9 is a flowchart illustrating a process performed by the work support apparatus 100. First, the area identification information converting unit 140 obtains article identification information on an article or a raw material to be extracted by the worker from the outside (step S10). The article identification information obtained by the area identification information converting unit 140 is input through an input unit provided in the work support apparatus 100, for example. The area identification information converting unit 140 reads the area identification information corresponding to the obtained article identification information from the article information storage unit 142 (step S20).

Further, the image analyzing unit 110 receives and analyzes the image data obtained by an imaging of the imaging unit 210 to calculate the position of the hand in the X direction in FIG. 1, for example (step S30).

Further, a disposition position specifying unit 120 receives the distance of the hand in the Y direction in FIG. 1, for example, from a distance measuring unit 220 (step S40). Further, the disposition position specifying unit 120 reads the area identification information on the disposition area 310 to which the hand extends based on the position of the hand calculated by the image analyzing unit 110 and the distance of the hand calculated by the distance measuring unit 220 from the area information storage unit 122 (step S40).

Further, the disposition position specifying unit 120 determines whether the area identification information read by the disposition position specifying unit 120 in step S40 and the area identification information read by the area identification information converting unit 140 in step S20 coincide with each other (step S50). If it is determined that the two pieces of area identification information do not coincide with each other (step S50: No), the alarm unit 130 performs an alarm process, for example, a process of outputting an alarm sound (step S60). If the area identification information read by the disposition position specifying unit 120 and the area identification information read by the area identification information converting unit 140 in step S20 coincide with each other, the disposition position specifying unit 120 may perform a process of indicating the fact (for example, a process of outputting a sound different than the alarm sound).

As described above, according to the present embodiment, it is possible to achieve the same effects as in the first embodiment. Further, when the worker extracts a wrong article or raw material, the alarm unit 130 performs an alarm process. Accordingly, it is possible to prevent the worker from extracting the wrong article or raw material.

### Fourth Embodiment

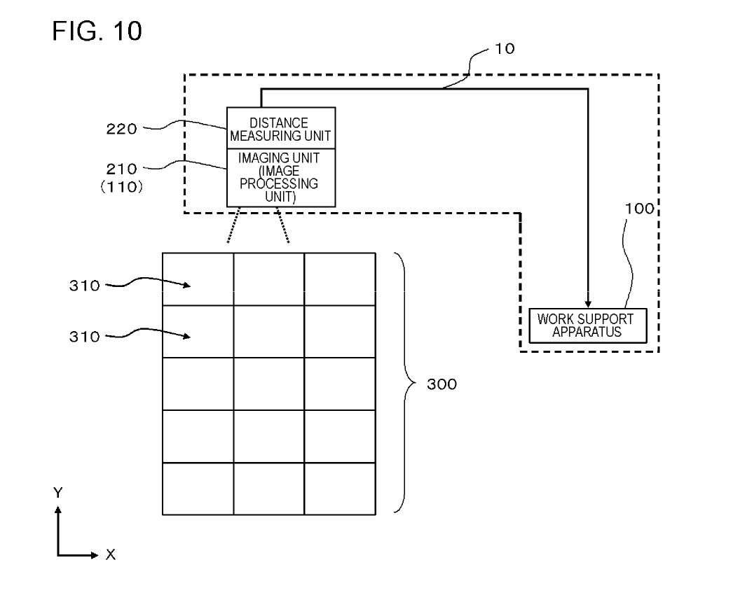

FIG. 10 is a block diagram illustrating a configuration of a work support system. 10 according to a fourth embodiment.

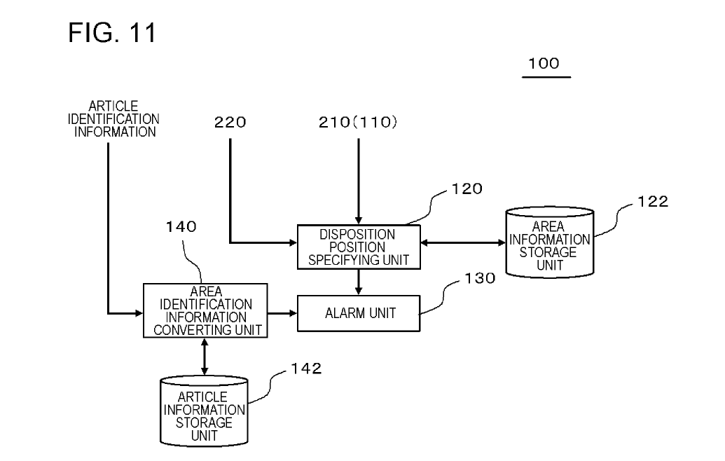

FIG. 11 is a block diagram illustrating a functional configuration of a work support apparatus 100 shown in FIG. 10. The work support system 10 according to the present embodiment has the same configuration as in the work support system 10 shown in FIG. 3 except that an image analyzing unit 110 is assembled in an imaging unit 210 instead of the work support apparatus 100.

According to the present embodiment, similarly, it is possible to achieve the same effects as in the third embodiment. Further, if an imaging unit 210 in which the image analyzing unit 110 is assembled is available in the market, it is possible to reduce the manufacturing cost of the work support apparatus 100 by using this imaging unit 210.

Here, in the first or second embodiment, the image analyzing unit 110 may be assembled in the imaging unit 210 instead of the work support apparatus 100, similar to the present embodiment.

### Fifth Embodiment

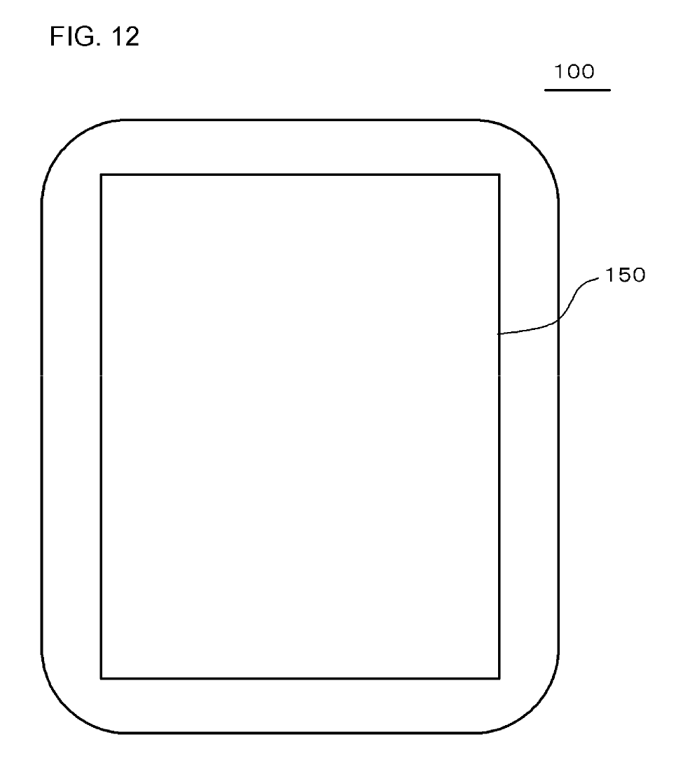

FIG. 12 is a plan view illustrating a work support apparatus 100 according to a fifth embodiment. A work support system 10 according to the present embodiment has the same configuration as in the work support system 10 according to the fourth embodiment except for a configuration of the work support apparatus 100.

In the present embodiment, the work support apparatus 100 is a tablet type portable terminal, which includes a display unit 150. The display unit 150 includes a display, and can be carried by the worker. Here, the work support apparatus 100 may be a mobile phone terminal or a sunglasses type terminal.

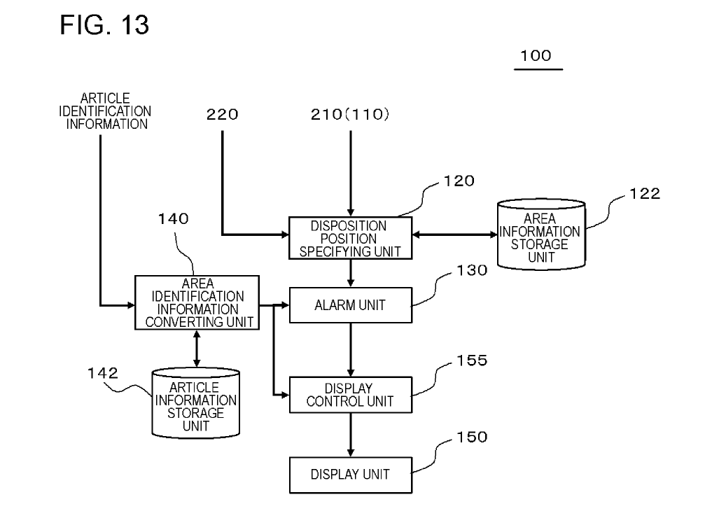

FIG. 13 is a block diagram illustrating a functional configuration of the work support apparatus 100 shown in FIG. 12. The work support apparatus 100 according to the present embodiment has the same configuration as in the work support apparatus 100 according to the third embodiment, except for inclusion of a display control unit 155 and the display unit 150.

The display control unit 155 generates information to be displayed in the display unit 150. Specifically, the display control unit 155 allows the display unit 150 to display the place of the disposition area 310 where an article or a raw material to be extracted by the worker is disposed based on the area identification information specified by an area identification information converting unit 140. Further, when the worker extends the hand toward a wrong disposition area 310, the display control unit 155 allows the display unit 150 to display an alarm based on the output of the alarm unit 130. Here, the display control unit 155 may allow the display unit 150 to display a correct place of the disposition area 310. Further, the display control unit 155 may allow the display unit 150 to display the place to which the worker extends the hand, that is, the specification result in a disposition position specifying unit 120. Further, when the worker extends the hand toward the correct disposition area 310, the display control unit 155 may allow the display unit 150 to display article specification information (for example, a name) on the article to be extracted from the disposition area 310 (or to be disposed in the disposition area 310) or the number of the articles.

According to the present embodiment, similarly, it is possible to achieve the same effects as in the third embodiment. Further, the work support apparatus 100 is the portable terminal, and the place of the disposition area 310 where the article or the raw material to be extracted by the worker is disposed is displayed in the display unit 150. Accordingly, it is possible to suppress the worker from extracting a wrong article or raw material.

In the first to third embodiments, the work support apparatus 100 may be the same as in the present embodiment.

### Sixth Embodiment

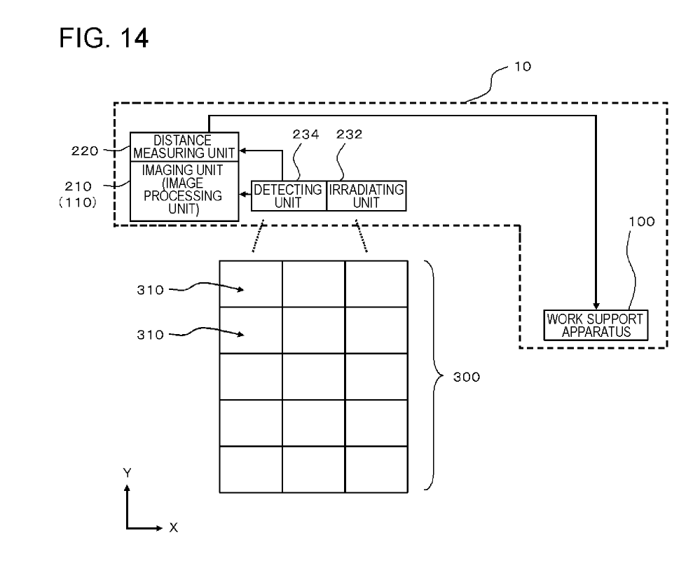

FIG. 14 is a diagram illustrating a configuration of a work support system 10 according to a sixth embodiment. The work support system 10 according to the present embodiment has the same configuration as in the work support system 10 according to the fourth embodiment except for inclusion of an irradiating unit 232 and a detecting unit 234.

The irradiating unit 232 irradiates the disposition unit 300 with a dot-shaped infrared ray or a supersonic wave while scanning the front side of the disposition unit 300. The detecting unit 234 detects a reflected wave of the infrared ray or the supersonic wave irradiated by the irradiating unit 232. The detecting unit 234 outputs the detection result of the reflected wave to an imaging unit 210 and a distance measuring unit 220.

Here, the detecting unit 234 measures a time period from the time when the irradiating unit 232 irradiates the infrared ray or the supersonic wave to the time when the reflected wave is detected. The distance measuring unit 220 receives the measured time period from the detecting unit 234. Further, the imaging unit 210 and the distance measuring unit 220 receive a direction in which the irradiating unit 232 irradiates the infrared ray or the supersonic wave from the irradiating unit 232 or the detecting unit 234.

The imaging unit 210 generates image data based on the detection result of the reflected wave in the detecting unit 234 and the direction in which the irradiating unit 232 irradiates the infrared ray or the supersonic wave. Further, the imaging unit 210 analyzes the generated image data to calculate the angle of a straight line that connects the imaging unit 210 and the hand. In the present embodiment, similarly, for example, the center of the image data is set as the origin (zero point) of the angle, but a different point may be set as the origin. This calculation result is output to the disposition position specifying unit 120 of the work support apparatus 100.

The distance measuring unit 220 calculates the position of the hand in the first direction (in the Y direction in the drawing) based on the time period from the time when the irradiating unit 232 irradiates the infrared ray or the supersonic wave to the time when the reflected wave is detected and the direction in which the irradiating unit 232 irradiates the infrared ray or the supersonic wave. This calculation result is output to the disposition position specifying unit 120 of the work support apparatus 100.

According to the present embodiment, similarly, it is possible to achieve the same effects as in the fourth embodiment.

### Seventh Embodiment

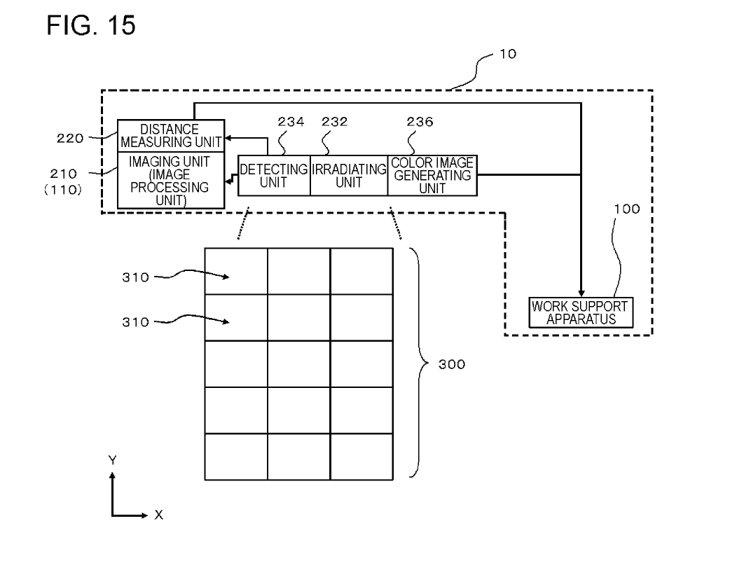

FIG. 15 is a diagram illustrating a configuration of a work support system 10 according to a seventh embodiment. The work support system 10 according to the present embodiment has the same configuration as in the work support system 10 according to the sixth embodiment except for inclusion of a color image generating unit 236.

The color image generating unit 236 generates color image data on the front side of a disposition unit 300, and outputs the generated color image data to a work support apparatus 100. A disposition position specifying unit 120 of the work support apparatus 100 determines whether the hand detected by the imaging unit 210 is a falsely detected object, that is, whether the object detected by the imaging unit 210 is the hand, using color information of the received color image data.

According to the present embodiment, similarly, it is possible to achieve the same effects as in the sixth embodiment. Further, it is possible to suppress a different object (for example, the head or the like) positioned in front of the disposition unit 300 from being falsely detected as the hand.

Hereinbefore, the embodiments of the invention are described with respect to the accompanying drawings, but these embodiments are only exemplifications of the invention, and other various configurations may be employed.

This application is based upon and claims the benefit of priority from Japanese Patent Application No. 2012-22312, filed on Feb. 3, 2012, the entire disclosure of which is incorporated herein by reference.

1. A work support system comprising:
an image generating unit that generates image data indicating an area in front of a disposition unit in which a plurality of disposition areas where an article is to be disposed are arranged;
a distance measuring unit provided in a first direction with reference to the disposition unit that measures a distance to a hand that extends toward the disposition unit;
an image analyzing unit that analyzes the image data and calculates an angle of a straight line that connects the image generating unit and the hand; and
a disposition area specifying unit that specifies the disposition area to which the hand extends based on the analysis result of the image analyzing unit and the measurement result of the distance measuring unit.

2. The work support system according to claim 1, further comprising:
an irradiating unit that irradiates the hand with an infrared ray or a supersonic wave; and
a detecting unit that detects a reflected wave of the infrared ray or the supersonic wave,
wherein the image generating unit generates the image data based on the detection result of the detecting unit, and
wherein the distance measuring unit calculates the distance to the hand based on the detection result of the detecting unit.

3. The work support system according to claim 1, further comprising:
a color image generating unit that generates color image data on the area in front of the disposition unit,
wherein the image analyzing unit determines whether an object in the image data is the hand based on color information of the color image data.

4. The work support system according to claim 1,
wherein specific area identification information is assigned to the plurality of disposition areas, and
the work support system further comprises:
an area identification information obtaining unit that obtains the area identification information on the disposition area to which the hand is to extend; and
a determining unit that determines whether the disposition area indicated by the area identification information obtained by the area identification information obtaining unit and the disposition area specified by the disposition area specifying unit coincide with each other.

5. The work support system according to claim 4, further comprising:
an alarm unit that performs an alarm process if the determining unit determines that the disposition areas do not coincide with each other.

6. The work support system according to claim 1, further comprising:
an area information storage unit that stores a position range of the hand in the first direction and a position range of the hand in a second direction that is across the first direction, respectively, for each of the plurality of disposition areas,
wherein the disposition area specifying unit specifies the disposition area to which the hand extends using information stored in the area information storage unit.

7. The work support system according to claim 1,
wherein the image generating unit is provided above the disposition unit.

8. A work support apparatus that is connected to a measuring unit including
an image generating unit that generates image data indicating an area in front of a disposition unit in which a plurality of disposition areas where an article is to be disposed are arranged,
a distance measuring unit provided in a first direction with reference to the disposition unit for measuring a distance to a hand that extends toward the disposition unit, and
an image analyzing unit that analyzes the image data and calculates an angle of a straight line that connects the image generating unit and the hand,
the work support apparatus comprising:
a disposition area specifying unit that specifies the disposition area to which the hand extends based on the analysis result of the image analyzing unit and the measurement result of the distance measuring unit.

9. The work support apparatus according to claim 8,
wherein specific area identification information is assigned to the plurality of disposition areas, and
the work support apparatus further comprises:
an area identification information obtaining unit that obtains the area identification information on the disposition area to which the hand is to extend; and
a determining unit that determines whether the disposition area indicated by the area identification information obtained by the area identification information obtaining unit and the disposition area specified by the disposition area specifying unit coincide with each other.

10. The work support apparatus according to claim 9, further comprising:
an alarm unit that performs an alarm process if the determining unit determines that the disposition areas do not coincide with each other.

11. The work support apparatus according to claim 8, further comprising:
area information storage unit for storing a position range of the hand in the calculation result of the image analyzing unit and a position range of the hand in the measurement result of the distance measuring unit, respectively, for each of the plurality of disposition areas,
wherein the disposition area specifying unit specifies the disposition area to which the hand extends using information stored in the area information storage unit.

12. A work support method using a work support apparatus that is connected to a measuring unit including
an image generating unit that generates image data indicating an area in front of a disposition unit in which a plurality of disposition areas where an article is to be disposed are arranged,
a distance measuring unit provided in a first direction with reference to the disposition unit for measuring a distance to a hand that extends toward the disposition unit, and
an image analyzing unit that analyzes the image data and calculates an angle of a straight line that connects the image generating unit and the hand,
wherein the work support apparatus
obtains the analysis result of the image analyzing unit,
obtains distance information that is the measurement result of the distance measuring unit, and
specifies the disposition area to which the hand extends based on the analysis result and the distance information.

13. A computer readable storage medium storing a program that causes a computer that is connected to a measuring unit to function as a work support apparatus, the measuring unit including
an image generating unit that generates image data indicating an area in front of a disposition unit in which a plurality of disposition areas where an article is to be disposed are arranged,
a distance measuring unit provided in a first direction with reference to the disposition unit that measures a distance to a hand that extends toward the disposition unit, and
an image analyzing unit that analyzes the image data and calculates an angle of a straight line that connects the image generating unit and the hand,
wherein the program causes the computer to realize:
a function of obtaining the analysis result of the image analyzing unit;
a function of obtaining distance information that is the measurement result of the distance measuring unit; and
a function of specifying the disposition area to which the hand extends based on the analysis result and the distance information.

14. The computer readable storage medium according to claim 13,
wherein specific area identification information is assigned to the plurality of disposition areas, and
the program causes the computer to further realize:
a function of obtaining the area identification information on the disposition area to which the hand is to extend; and
a function of determining whether the disposition area indicated by the obtained area identification information and the disposition area specified by the disposition area specifying function coincide with each other.

15. The computer readable storage medium according to claim 13,
the program causes the computer to further realize a function of performing an alarm process if it is determined that the disposition areas do not coincide with each other.

16. The computer readable storage medium according to claim 13,
the program causes the computer to further realize a function of storing a position range of the hand in the first direction and a position range of the hand in a second direction that is across the first direction, respectively, for each of the plurality of disposition areas, and
wherein the disposition area specifying function specifies the disposition area to which the hand extends using information stored by the storing function.
